(19) United States
(12) Patent Application Publication
(10) Pub. No.: US 2008/0249860 A1
(43) Pub. Date: Oct. 9, 2008

(54) Bonus system with rule based customization

(75) Inventors: Marcus Carotta, Munchen (DE); Markus Kleinfelder, Starnberg (DE); Dirk Lenzkes, Dusseldorf (DE); Othmar Klaassen, Moers (DE); Dirk Schreib, Dusseldorf (DE)

Correspondence Address: FROST BROWN TODD, LLC, 2200 PNC CENTER, 201 E. FIFTH STREET, CINCINNATI, OH, 45202, US

(73) Assignee: Loyalty Partner GmbH, Munchen (DE)

(21) Appl. No.: 11/775,258

(22) Filed: Jul. 10, 2007

(30) Foreign Application Priority Data
Apr. 5, 2007 (DE) DE102007016607

(51) Int. Cl. G06Q 30/00

(52) U.S. Cl. 705/14

(57) ABSTRACT

A computer program product includes program code, stored on a machine readable medium, or provided in the form of a propagated signal, wherein the program code, when executed on a computer system, implements a bonus system, and allows the implementation of bonus programs, wherein several bonus program partners can participate in a bonus program. Bonus program members can collect bonus points during transactions with a bonus program partner, wherein the program code allows a customization of various bonus system functions through rules through a central interface.

### FIELD OF THE INVENTION

The present invention relates to bonus systems and, in particular, to bonus systems, in which various components of the system are configured through user defined rules, through an interface.

### BACKGROUND OF THE INVENTION

Customer retention systems are very popular with businesses and also with customers. For customers there is the opportunity to receive bonuses or rebates from a vendor or a group of vendors, while businesses can thereby retain a customer long-term.

Customer loyalty means the loyalty of customers towards their favorite brands, products, and services. In the B2B area this means the loyalty of businesses towards vendors and service providers. Customer loyalty is an indicator for the reliability or dependability of the customers. Loyal customers can identify with the business, and they are supporters of the products and services provided. A prerequisite for customer loyalty is customer satisfaction.

An example for such a customer retention system is the Payback®-System of the applicant. Payback card holders can collect points in businesses of almost any kind. A point has the equivalent value of one cent. Most of the time points with a value of 0.5 to 4% of the purchase price are received. Furthermore, there are various coupons, which are sent to users on a regular basis, through which received rebates can be additionally increased. As soon as 200 points are collected in a Payback account, they can be redeemed for bonuses. Payback is the leading bonus program in Germany with 26.5 million distributed cards.

Computer implemented customer retention systems, in which customers collect bonus points in business transactions are known e.g. from WO 99/20013 and EP 1 134 677 A1.

On the technology side, customer retention systems entail a very substantial effort. These are complex, distributed applications, which access several databases, managing customer and partner specific data. Partners in this case are businesses participating in a common customer loyalty system. Components of such a system typically are components for computing the number of collected points in a customer transaction, components for computing the number of required points for a bonus, but also components for settling with partners. Furthermore, in such customer loyalty systems, customers are also provided with the opportunity to profit from special promotions over a certain period of time.

With this background, the present invention is based on the problem to provide such bonus systems, so they can be individually and simply adapted to the requirements of the business(es).

### SUMMARY OF THE INVENTION

The invention relates to a computer program product comprising program code, stored on a machine readable medium, or provided in the form of a propagated signal, wherein the program code, when it is executed on a computer system, implements a bonus system and allows setting up bonus programs, wherein several bonus program partners can participate in a bonus program. Bonus program members can collect points in transactions with a bonus program partner, wherein the program code allows a customization of various bonus system functions, with the help of rules for a central interface.

An additional aspect relates to a computer system for hosting a bonus system, allowing the setup of bonus programs, wherein several bonus program partners can participate in a bonus program. Bonus program members can collect bonus points in transactions with a bonus program partner, wherein the bonus program allows a customization of various bonus system functions through rules through a central interface.

Further features are included in the disclosed devices and methods, or can be derived by a person skilled in the art from the subsequent detailed description of embodiments and from the appended drawings.

### SHORT DESCRIPTION OF THE DRAWINGS

Embodiments of the invention are now described in an exemplary manner with reference to the appended drawings, in which:

FIG. 1 shows an abstract architecture diagram of a computer program, which implements a part of a bonus system, which is customizable through rules;

FIG. 2 illustrates a user interface of a central interface, through which particular functions of the bonus system can be customized through user defined rules, according to an embodiment of the invention;

FIG. 3 illustrates the function of the Rete-Algorithm, through which the rules can be analyzed in an efficient manner according to an embodiment of the invention;

FIG. 4a illustrates a first simple rule, which can be used for customizing a bonus system function, according to an embodiment of the invention;

FIG. 4b illustrates a more complex rule, which can be used for customizing a function of the bonus system, according to an embodiment of the invention;

FIG. 5 is a diagram illustration of an embodiment of a bonus computer system.

The drawings and the descriptions of the drawings relate to embodiments of the invention and not to the invention itself.

### DESCRIPTION OF PREFERRED EMBODIMENTS

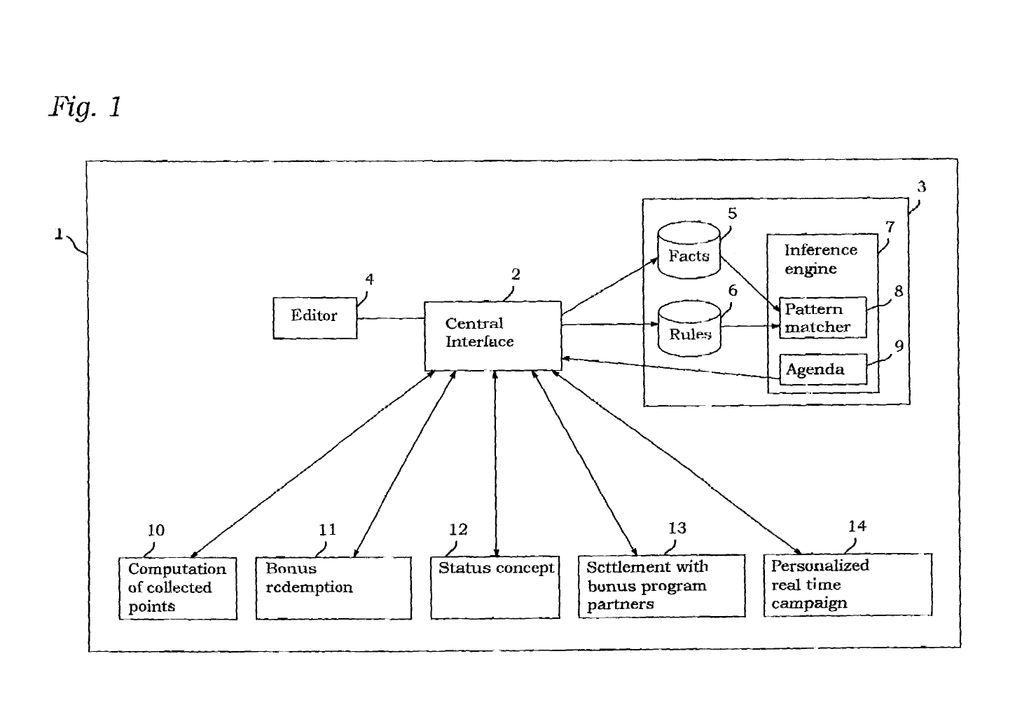

FIG. 1 illustrates an architecture of a ruled based part of a computer implemented bonus system. Previous to a detailed description of FIG. 1, and of the remaining figures, various descriptions related to the embodiments are being given.

### Terminology

Initially we would like to clarify the terminology used. Going from more general terms to more specific terms, initially the term “bonus system” is addressed, it includes the entire functionality of the computer program described herein. The bonus system can comprise several so-called “bonus programs”. Under a bonus program, several different vendors (this means, vendors of products or services) can give bonuses to their customers, which they can collect and redeem for several vendors combined. Thus, under a bonus program, several vendors act as a unit with reference to bonuses. In a marginal case, a “bonus program” can comprise only one vendor. The vendors, which belong to the same bonus program, are called “partners of the bonus program” in this text, or abbreviated, “bonus program partners”. Their customers, who accumulate bonus points associated with the bonus program in a transaction (thus e.g. a purchase of a product or a service), are being referred to as “members of the bonus program” or, abbreviated, “bonus program members” in the present text.

While in the past mostly customer retention service providers have provided participation in a single bonus program for as many “partners” as possible as a service, and have focused their development activity accordingly on the constant increase of the attraction of their bonus program, the present embodiments refer to a computer program, which allows a customized implementation of a bonus program. A business, which does not want to use an external service provider any more, but wishes to set up a bonus system for their own purposes, or wishes to provide the operation of a bonus system as a service for third parties, does not have to implement it themselves, but only has to customize the subsequently described computer program.

### Central Interface

Several embodiments relate to a computer program implementing a bonus system, and allowing the implementation of bonus programs, wherein several bonus program partners can participate in a bonus system.

Bonus program members can collect bonus points in transactions with a bonus program partner, wherein the bonus program allows a customization of bonus program functions through the rules and through a central interface. The rule based configuration of the computer program allows the configuration of the process logic without changes to the core system.

In some embodiments, the customization of the bonus system functions is performed by the buyer of the software (=bonus system operator, -user) himself, who can customize the supplied software according to his requirements. In case the customization of the program is too complex for the bonus system operator, he can turn to an external service provider, who takes over the customization for him. As an alternative, the bonus system operator can also use exemplary rules provided by the software provider.

In some embodiments, the interpretation of the rules is performed with the Rete-Algorithm. This algorithm, developed by Charles Forgy at Carnegie Mellon University in 1979, is a network based algorithm and forms the base for many new developments (Jess, Ilog Jrules, IBM Common Rules). A goal of this algorithm is efficiency increase; this means a reduction of the database entries which have to be examined. In the Rete-Algorithm, a given set of 30 rules is combined into a dataflow graph, so that similar components of the rule premises occur in the dataflow graph only once. For the interpretation of the rule, only a small part of the random access memory is being used. A further object is the reduction of the conditions to be tested. Since the premises (conditional components) of the rules are generally not separate, the effort for the recognition phase can also be minimized through performing similar tests only once. Conditions of the Rete-algorithm are that the random access memory only changes slowly. A matching (=a domain object fulfills a part of a premise of a rule) is not repeated. Each information is stored in the network, this means duplication over time is avoided. The conditions of the rules are represented by a network of tests, so that common test conditions are only tested once. The Rete-Algorithm also leads to a reduction of the fact base entries to be examined. A change in the random access memory is immediately announced by the network.

The Rete-Algorithm is performed by so-called rule engines, which are mentioned in the context with declarative program languages (Prolog, etc.). Rule engines or declarative programming languages aim at saying “what to do” instead of saying “how to do it” (procedural programming languages). The main advantage of rule engines is, that it is simple to provide rules for difficult problems and, therefore, to verify these solutions (rules are easier to read than procedural code).

Rule engines are based on a separation between data and rules. The data are in the domain objects, the logic is in the rules. This concept is in fundamental contradiction to the object oriented coupling between data and logic. The advantage of this separation of rules and data is that the logic is easier to maintain, when the changes are to be made in the future, since the logic is structured in rules.

The Rete-Algorithm provides very efficient possibilities of matching rule patterns with domain objects. This, however, is efficient in particular when the datasets do not change completely, since the rule engine can recall previous matches.

In some embodiments, the open source rule engine “Drools” is used, which is based on the Rete-Algorithm. While the rule engines can solve a multitude of problems for us, it is worthwhile to consider, if a rule engine is intended for a Java enterprise application. Rule engines are used in particular preferably for business applications, when the requirements for the business application change during or after their development. “Drools” helps to perform these changes through easily configurable XML files.

There are tools offering possibilities to edit and manage rules. These tools offer direct feedback, validation, and assistance.

It was recognized that rule systems are suitable for codification or business process rules. The use of rules also allows modeling the problem domain. The rules can reproduce the natural language better, than complex procedural program code. They are suitable for logic, which are understandable for domain experts, who are not technicians. In some embodiments, also a non technician can easily customize the rules after having worked through the rule syntax.

Domain experts, or business analysts, are easily available, but do not have a sufficient technical background, in order to formulate complex program code. Non technical domain experts often have a wealth of knowledge about business rules. These are mostly not procedural-algorithmic, but can still be very logical. Rules can allow these people to express the logic in their own thoughts. Business people certainly have to be capable of critical deliberation and logical thinking.

In some embodiments, the rule based cutout of a bonus system, shown in FIG. 1, is embedded into a modern object oriented application.

Through user defined rules, defined by the buyer of the software, components of the application can be customized. The components are programmed once by the producer of the application and can then be adapted to the requirements of the buyer through the rules, wherein the core system is not changed. The customization via a central interface thus allows adapting the software to the different requirements of different bonus system operators in a individual manner.

In other embodiments, the rule engine is implemented through “Groovy” a script language. Script languages are programming languages, which are intended in particular for small and clear programming tasks. They relinquish certain language elements, whose use only becomes apparent when working on larger projects. Thus in script languages the declaration requirement of variables is relinquished, which is advantageous for the quick development of small programs. In large programs, on the other hand, this is a disadvantage, thus because of the lacking testing capability for typographical errors in names of variables. Programs, which are written in script language, are also being called scripts. Scripts are almost exclusively delivered in the form of source text files, in order to allow thus a simple processing and adapting of the program. “Groovy” is a dynamic programming language and script language for the Java Virtual Machine of James Strachan. Groovy includes certain features which are not included that way in Java: closures, native syntax for maps, lists and regular expressions, a simple template system, through which HTML and SQL code can be generated, a syntax similar to XQuery for executing object trees and operator downloads and a native depiction for BigDecimal and BigInteger. It is appreciated that Groovy, unlike other script languages, is not executed through an interpreted abstract syntax tree, but it is directly translated into Java byte code before the execution of a script.

In other embodiments the customization of the program is performed through a Java package, which assures the direct definition of rules and their evaluation. Defining the rules within a Java package, however, requires in depth programming knowledge of a Java programmer, so that it is more difficult to operate for the user, than when a user interface is provided to him, through which he can specify rules through a relatively simple syntax.

Besides the three presented possibilities (Drools, Groovy, and direct programming in Java) certainly any other rule engine can be employed.

In some embodiments, in order to increase user friendliness, rule template (patterns, templates) are provided to the user, through which he can configure rules in a simple manner, in order to adapt the bonus system software to his requirements.

In other embodiments, rule templates are provided, which relate to certain parameters. The associated parameter data is stored separate from the templates in a database.

In some embodiments, the rules are thematically combined into rule sets, so that the user can perform a structuring within the rules, in order to maintain certain clarity.

### Customizable Bonus System Functions

Subsequently, some bonus system functions are addressed, which are customized through rules, through a central interface. These functions comprise e.g. calculating collected points in a customer transaction. The collected points can be bonus points, which are an indicator, how many purchases a customer has made already, or they can be status points, which state which status a customer has within the bonus system. Initially a customer may e.g. have a “Bronze” status, which entitles him to select certain smaller bonus presents. However, when the customer performs further purchases, thereby improving his status, he can apply for Silver, Gold, or Platinum status, allowing a choice among larger bonus presents.

In some embodiments, rules are being used, which allow a combination of several, also time wise separate, transactions into an additional “reward” in the form of bonus- or status points.

In other embodiments, configurable bonus system functions relate to calculating required points for redeeming a bonus, thus bonuses are only available for customers of a certain status, or a certain status amount.

In other embodiments, the bonuses are time limited in the form of campaigns. This can be performed in special embodiments on a daily recurring basis at certain times of the day. These campaigns are often also called “happy hour campaigns”.

In some embodiments, different types of points can be combined, and a corresponding bonus offer is suggested to the customer.

In other embodiments, rules are defined, which determine an age based expiration of the collected points. For different types of points, different kinds of expiration can be defined. Some points can already expire after a couple of months, while other points are being collected over several years.

In some embodiments, it is provided in the calculation of the required points, which are necessary for redeeming a bonus that, in consideration of the previous transactional behavior of the customer, the number of required points is lowered.

In other embodiments, configurable special rules are provided, which allow converting the collected points into other virtual currencies or into point donations.

In some embodiments, it is provided, that any number of status values can be configured. Thus any transitions between different status values are configured, depending on all properties of a customer, taking history into account.

In other embodiments, the program part for settling with partners comprises a management of the amounts to be paid for the points. This program part is also concerned with the computation of service fees for awarding points, collecting points, canceling transactions, and with campaign specific services, and can be customized through rules, through a central interface.

In some embodiments, the component for settling with partners also comprises reimbursing expired points to the original issuing partner,

In other embodiments, personalized real time campaigns are being performed through crediting premium points during special activities in the context of the access to the web site of the bonus program partner. These activities can e.g. be answering an online request.

In some embodiments, personalized real time campaigns are being performed at the point of sale, e.g. also at the cash register in the form of an expanded receipt.

In some embodiments, the personalized real time campaigns are designed depending on features of the customer in consideration of the history.

Some embodiments relate to a computer system for hosting a bonus system, which allows setting up bonus programs, wherein several bonus program partners can participate in a bonus program. Bonus program members can collect bonus points through transactions with a bonus program partner, wherein the bonus system allows a customization of bonus system functions through rules through a central interface.

Some embodiments of the computer program comprise a machine readable medium, which is capable to store the program code or to code it. The expression “machine readable medium” shall be defined so that it comprises e.g. solid state memories and removable or non removable optical and magnetic storage media. In other embodiments, the computer program is to be distributed in the form of a propagated signal with an embodiment of the program code, what becomes increasingly the typical manner to distribute software. The signal is transported e.g. on an electromagnetic wave, e.g. via a copper cable, or through the air, or through a light wave transmitted by glass fiber cable. The program code can be machine code, or another code, written in machine code as e.g. source code in a multipurpose programming language, e.g. C, C++, Java, C#, etc. The embodiments of a computer system can be commercially available multipurpose computers, which are programmed with the program code.

Returning now to FIG. 1, it shows the schematic configuration of a computer program for implementing a rule based part of a bonus system 1. It is appreciated that FIG. 1 only shows the component of a bonus system 1, which includes the computer program components, which deal with the customization of the bonus system 1 through rules. It is self evident, that a complete bonus system includes many more program components than the ones illustrated here. The computer program has a central interface 2, which is connected with a rule engine 3, which performs the rule evaluation. Through the central interface 2, different program components can be influenced through the definition of rules, so that a customization of the bonus system 1 can be performed thereby. An editor 4 is provided as a user interface, through which already existing rules can be modified or new rules can be created. Initially, a program component is selected, which is to be customized through rules, and the facts and rules appearing therein, or present therein are loaded into a fact database 5 or into a rule database 6 in a preliminary manner. Existing rules can be changed, or new rules can be entered via the entry window 21. The rules and the facts are read into an inference engine 7, in which a pattern matcher 8 matches the premises of the rules with the facts from the fact base 5.

In information technology, a conclusion is sometimes called inference”. In information technology the word “inference” is used for such conclusions, which are derived in an automated manner, this means computer based. The inference engine 7 is thus capable, due to the rules given in the rule base 6 and due to the facts given in the fact database 5 to generate new facts, this means expand the fact database. Therefore, the inference engine 7 has to compare the premises of the rules with domain objects from the fact database 5. A PROLOG-interpreter (“Programming in Logic”) is an example for an inference engine. Within the inference engine 7 furthermore an agenda 9 is provided, in which the conclusions or actions are stored, which are performed, when the premise of a rule in the fact database 5 could be verified.

A first program component, which can be customized through the rules, is the program component 10, which relates to calculating the bonus points accumulated by the customers. A program component for calculating the bonus redemption 11 can also be adapted to customer requirements through rules. A status concept program component 12 allows defining rules, providing what number of bonus and/or status points is necessary to obtain a certain status. The program component 13, which relates to settling with the bonus program partners, can also be configured through rules. Furthermore, the program component 14, which is used for personalized real time campaigns, can be adapted to the requirements of the customer through rules. When a rule premise was able to be verified, the agenda 9 is performed and thereby new knowledge (facts) is generated, which is transferred to the particular program components 10-14 through a center interface 2.

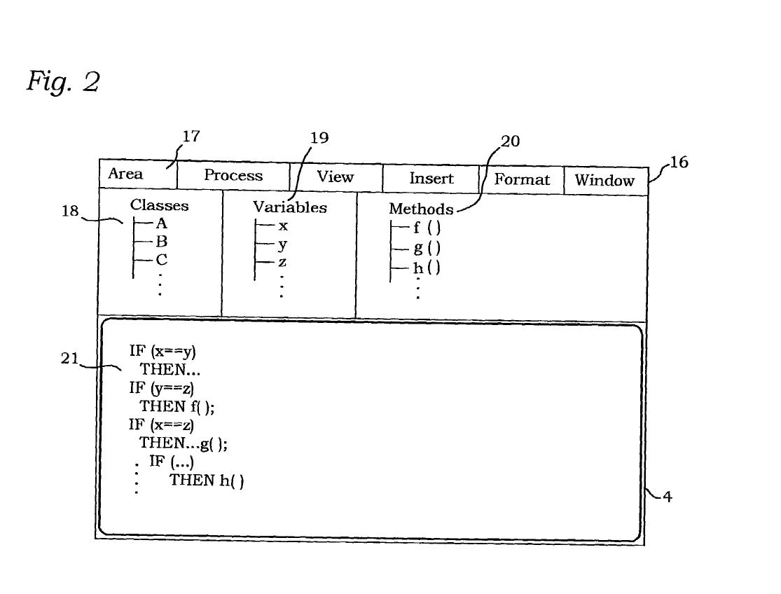

FIG. 2 shows a user interface in the form of an editor 4 for the central interface 2 of the bonus program, through which the rules of the bonus system can be entered. In a menu line 16 a number of menu items are available to the user. A menu item “area” 17 provides that the rule programmer can select the area of the bonus system, which he wants to customize through the rules. The areas can be the areas shown in FIG. 1, program components 10-14. After the rule programmer has selected an area, an overview of the classes 18, variables 19, and methods 20 is displayed to him in a designated area of the user interface. These program components are now available to the user, in order to design rules, which can then configure or customize the previously mentioned program components.

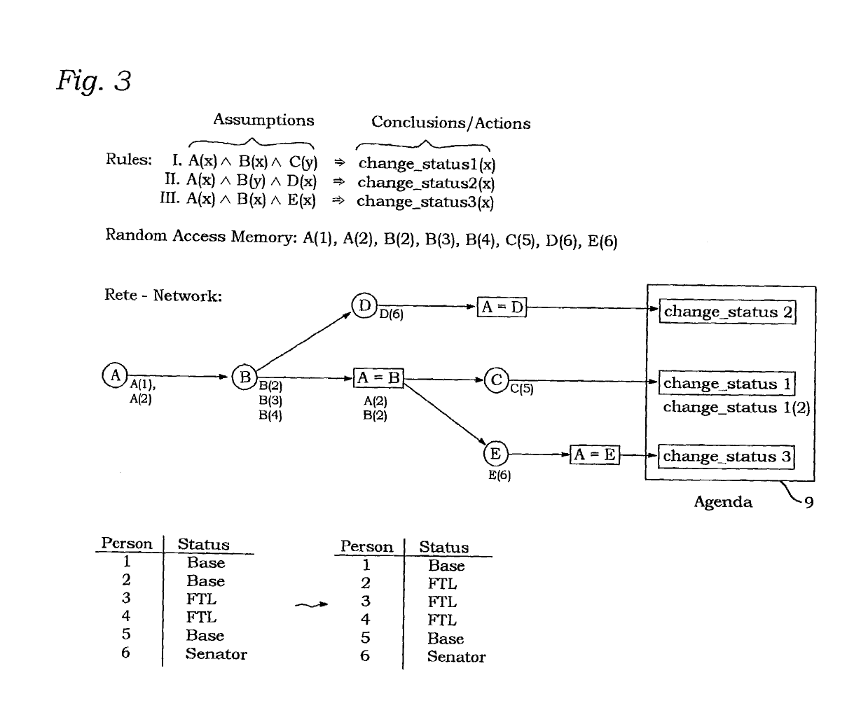

FIG. 3 illustrates the function of the Rete-Algorithm in an abstract manner, which is used in many rule based systems, in which efficiency is paramount. “Rete” is the Latin word for “net” and already infers, that the algorithm is targeted at combining identical rule premises, like a net. The Rete-Algorithm generates a decision network from a number of rule premises in the form of a data flow chart. The rule premises are also designated as LHS (left hand side). The conclusions or actions of a rule are called RHS (right hand side). The description of the algorithm is performed in a declarative programming language notation, as e.g. PROLOG. The fact or knowledge base is called a random access memory, in which information with respect to the particular persons (numbered from 1 through 6) is stored. Person 1 e.g. fulfills the predicate A, so that a A(1) could mean e.g. that the person 1 has purchased the product A. Formally, a predicate, e.g. A(x) is a depiction of domain objects into the Boolean values TRUE or FALSE. One can insert certain elements for x, in our case persons, and obtains, depending on the inserted value fulfilling the predicate, the value TRUE or FALSE. Since the Rete-Algorithm is only illustrated here in an abstract manner, the predicate A is not to be specified in more detail subsequently. A could also be a status entry, which the person 1 fulfills. Person 2 also fulfills the predicate A, person 2 fulfills the predicate B, person 3 fulfills the predicate B, person 4 fulfills the predicate B, person 5 fulfills the predicate C, and person 6 fulfills the predicate D.

The rules only provide a number of conditions on their left side, which lead to a status change, if they are fulfilled by domain objects in the fact base. Three different status change rules are determined, wherein the first status change rule I increases the status of a person by a degree, the second status change rule II increases the status of a person by 2 degrees, and the third status change rule III increases the status of a person by 3 degrees. The status are based on the Lufthansa miles and more bonus system and begin with “Base”, over “Frequent Traveler” and “Senator” up to “Honor”. It becomes evident that parts of the premises of the three rules are identical and eventually only have to be evaluated once. The Rete-Algorithm is thus capable to recognize the identical parts of the premises and to build a rule network there from, which allows an efficient evaluation of the rules. As can be seen in FIG. 3, A(x) is processed only once, this means it is only looked up once in the fact database, which persons fulfill the predicate A. These are the persons 1 and 2, which is also stored in the node A. Furthermore, it is being examined which persons fulfill the predicate B. From the fact bases it is evident that the persons 2, 3 and 4 fulfill this predicate. Now a first branching off occurs. On the one hand, it is being tested if the predicate D is fulfilled by one person. This predicate is fulfilled by the person 6. During the further examination, if a person is included in the fact base, which fulfills predicate A as well as predicate D, it is going to be determined that such person does not exist. The action “change_status2” is thus not performed in the present fact base. In another branch, however, it is being tested, if there is a person, who fulfills the predicates A and B. This question can be answered with yes, since the person 2 fulfills both predicates. Furthermore, it is being tested, if there is additionally a person, who fulfills the predicate C, and also this can be answered with yes, since the person 5 fulfills the predicate C. Thus the action “change status1” can be performed, which has the effect that that the person 2 is promoted by a status grade. The person 2, which had base status so far, is awarded FTL (Frequent Traveler Status). Following the dataflow chart further, the question arises, if a person fulfills the predicate E, wherein this only applies to the person 6. It is further tested, if there is a person who simultaneously fulfills the predicate A and the predicate E. Since such person does not exist in the fact database, the action “change_status3” is not performed. Thus none of the persons is promoted by 3 degrees of status.

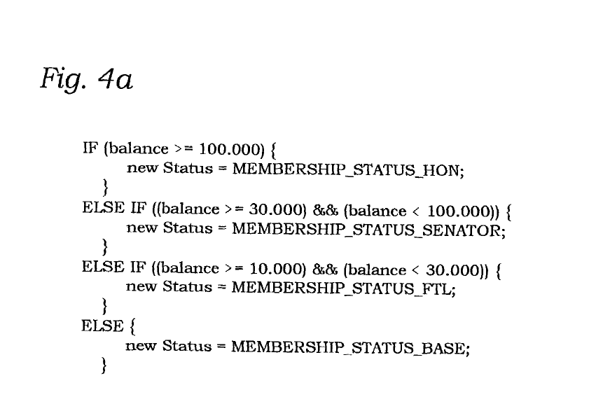

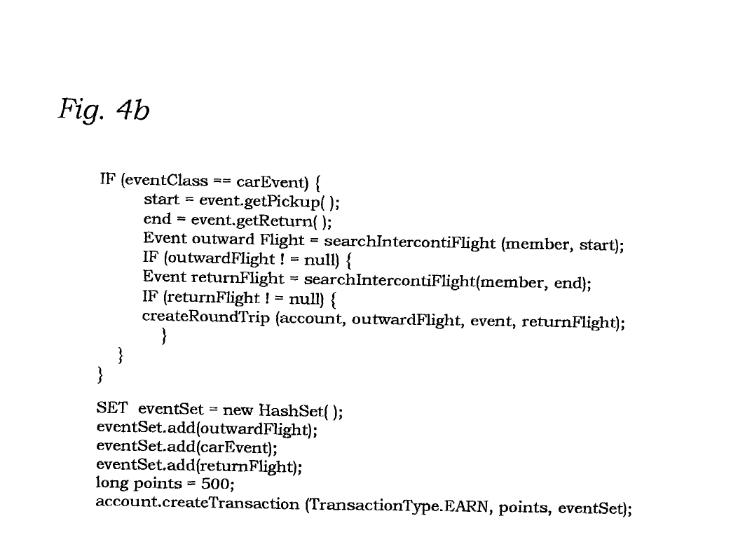

FIG. 4a shows a rule defined in the programming language “Groovy” in an exemplary manner, which is often used for rule programming, which is entered through the editor 4 of the central interface 2. Thereby the first rule again relates to the status concept of the Lufthansa®-Miles-and-More® bonus system. When the bonus point account of a customer goes over a certain value, a new status is awarded to him. At the beginning a base status is awarded to the traveler (Status_Base). The traveler retains this status until his bonus point account goes over a value of 10,000 points. When the customer has between 10,000 and 30,000 points in his account, a Frequent Traveler Status (Status_FTL) is allocated to him. In this range between 30,000 and 100,000 bonus points the traveler has a Senator status (Status_Senator), and above 100,000 bonus points, the customer reaches “Honor” status (Status_Hon).

FIG. 4b shows a second two-part rule, which relates to an identification of a round trip, comprising an intercontinental first leg, a booking of a rental car at that location, and an intercontinental return flight, and a subsequent point transaction to a bonus point account. When a customer has booked a rental car, an appropriate outbound flight and return flight is searched in the context of the booking time. The outbound and return flight are designated as outward flight or return flight events and booking the rental car is designated a car event. In case of an appropriate presence of all three events, a roundtrip is generated.

The second component of the rule in FIG. 4b illustrates the treatment of such a roundtrip. The outward flight, car- and return flight events are assembled into a set of events (event set), and 500 points are credited to the bonus account of the customer, who has booked the rental car.

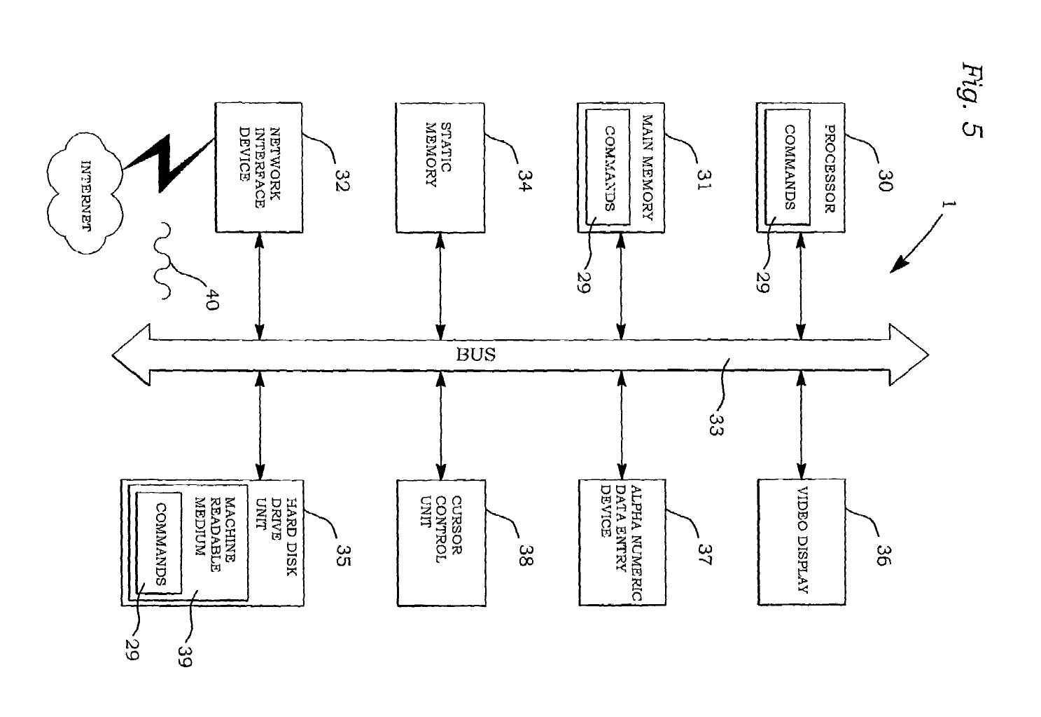

FIG. 5 is a diagram depiction of a computer system, which provides the functionality of the architecture of the bonus system 1 of FIG. 1, and which is therefore designated as bonus computer system 1. Within the bonus computer system 1, a set of commands 29 can be performed in order to cause the computer system to perform any of the methodologies discussed herein of a central rule interface 2 for customizing bonus system functions. The bonus computer system 1 comprises a processor 30, a main memory 31, and a network interface device 32, communicating amongst each other through a bus 33. It can optionally additionally comprise a static memory 34 and hard drive unit 35. A video display 36, an alphanumeric entry device 37, and a cursor control device 38 can form a user interface. The network interface device 32 connects the bonus computer system 1 with the internet. A set of commands (this means software) 29, embodying any or all of the above described methodologies, is partially or at least entirely in or on a machine readable medium 39, e.g. the main memory 31 and/or the processor 30. A machine readable medium 39, on which the software 29 is stored, can also be a data storage device, e.g. a non removable magnetic hard drive or an optical or a magnetic exchangeable drive, which is part of a disc drive unit 35. The software 29 can furthermore be transmitted or received as a propagated signal 40 through the internet through the network interface device 32.

Therefore, the described embodiments allow the customization of a bonus system through rules via a central interface.

All the publications and existing systems mentioned in this specification are incorporated in their entirety by reference.

Though certain methods and products which are composed according to the teachings of this invention, were described herein, the protection area of this Patent is not limited thereto. To the contrary, this Patent covers all embodiments of the teachings of the invention, which are within the scope of the appended claims, either literally, or through the doctrine of equivalency.

What is claimed is:

1. A computer program product comprising program code, stored on a machined readable medium, or provided in the form of a propagated signal, wherein the program code, when executed on a computer system, implements a bonus system and allows the implementation of bonus programs, wherein a plurality of bonus program partners can participate in a bonus system, and bonus program members can collect bonus points in transactions with a bonus program partner, wherein the program code allows a customization of several bonus system functions through rules through a central interface.

2. A computer program product according to claim 1, wherein the customization of bonus system functions comprises the definition of rules through a user.

3. A computer program product according to claim 1, wherein the rules are evaluated through the Rete-Algorithm through a rule engine.

4. A computer program product according to claim 1, wherein the rules are specified through the script based rules.

5. A computer program product according to claim 1, wherein the rules are defined within a Java package.

6. A computer program product according to claim 1, wherein the definition of rules is simplified through prefabricated rule templates.

7. A computer program product according to claim 1, wherein the rule templates are parameter specific, and the possible parameter data are stored separate from the templates in a database.

8. A computer program product according to claim 1, wherein the rules are combined into rule sets.

9. A computer program product according to claim 1, wherein the plural bonus system functions to be customized through the rules comprises the following functions:
computing the points collected in a customer transaction;
computing the points required for redeeming a bonus;
computing the behavior of points during age defined expiration;
defining a status concept;
settling with bonus program partners; and
performing personalized real time campaigns.

10. A computer program product according to claim 1, wherein the accumulated points are bonus points or status points.

11. A computer program product according to claim 1, wherein the number of points collected depends on any customer attributes.

12. A computer program product according to claim 1, wherein during the computation of the points required for redeeming a bonus, it is being considered that bonuses are only available for customers with a certain status.

13. A computer program product according to claim 1, wherein during the computation of the points required for redeeming bonus, the points required can be lowered in consideration of the previous transaction record of the customer.

14. A computer program product according to claim 1, wherein bonuses are only available on a time limited basis in the context of campaigns.

15. A computer program product according to claim 1, wherein various types of points can be combined and a convenient bonus offer is proposed to the customer.

16. A computer program product according to claim 1, wherein the points collected are converted into other virtual currencies.

17. A computer program product according to claim 1, wherein the component for settling with partners comprises managing the amounts to be paid for the points.

18. A computer program product according to claim 1, wherein the component for settling with partners comprises reimbursing expired points to the original issuing partner.

19. A computer program product according to claim 1, wherein the customer is credited points during special activities in the context of accessing the website of the bonus program partner.

20. A computer program product according to claim 1, wherein the personalized real time campaigns are designed depending on properties of the customer in consideration of the history.

21. A computer system for hosting a bonus system allowing the implementation of bonus programs, wherein several bonus program partners can participate in a bonus program, and wherein bonus program members can collect bonus points during transactions with a bonus program partner, wherein the bonus system allows a customization of various bonus system functions through rules through a central interface.
